(19) United States
(12) Patent Application Publication
(10) Pub. No.: US 2020/0063456 A1
(43) Pub. Date: Feb. 27, 2020

(54) Flood-Resistant Wall

(71) Applicant: Ruben Mendez, Houston, TX (US)

(72) Inventor: Ruben Mendez, Houston, TX (US)

(21) Appl. No.: 16/108,911

(22) Filed: Aug. 22, 2018

(51) Int. Cl. E04H 9/14

(52) U.S. Cl. CPC E04H 9/145; E06B 2009/007

(57) ABSTRACT

A wall panel for building construction comprising a frame made of a plurality of non-porous studs or channels; a flat wall material movably attached to the frame such that the flat wall material may be moved in preparation for a flood event; and one or more adjustable or telescoping legs pivotally attached to the flat wall material, the legs designed to hold the wall material substantially perpendicular to the floor in preparation for a flood event. The wall panel enables the home or business owner to lift the flat wall material out of harm's way in the event of an expected flood and further allows the home or business owner to store personal items on the wall panel in the event of an expected flood.

### FIELD OF THE INVENTION

The present invention relates to a wall structure comprising a frame made with a non-porous material such as stainless steel and further comprising sheetrock or another flat wall material connected to the frame in a way that allows for the flat wall material to be moved or raised in preparation for a flood event.

### BACKGROUND OF THE INVENTION

Flooding is a major problem throughout the United States and the world. After flood waters have receded, owners of flooded homes or businesses have several problems to deal with. One problem homeowners must deal with is removing any drywall damaged by flood water. Another problem homeowners have after a significant flood event is mold growth. It is very difficult and expensive to remediate mold growth after a significant flood event.

Porous building materials, such as wood, are prone to foster mold growth after a flood event. Mold can become trapped in porous wood and can be difficult, if not impossible, to remove from porous materials such as wood. Non-porous materials, such as stainless steel, are much less prone to fostering mold development.

Drywall is also very porous and fosters mold development in flooded homes. Experts recommend removing drywall as quickly as possible after a flood event to prevent mold from growing in the home and on the underlying porous wood studs.

Presently, wood studs are used to build walls in residential and commercial construction. Therefore, it is believed that there is a need and a large commercial market for a flood wall made of nonporous studs or channels that do not foster mold growth.

There is also a need and large commercial market for a wall with drywall attached to the frame in a manner that allows the drywall to be lifted up and away from the ground in anticipation of a flood event.

There is not currently a simple, reliable, and affordable method of preventing drywall damage and mold development in a building after a flood.

A wall in accordance with the present invention can be sold at a very reasonable price to contractors and homeowners around the world looking to improve the flood durability of their homes.

The present invention allows owners of flooded homes, insurance companies, and government entities such as FEMA to save money after a flood event. For example, because the homeowner can lift the drywall up and out of the way of impending floodwaters, there is no need to replace drywall after a flood event. Also, because stainless steel channels dry quickly without fostering mold growth, there is no need to replace the wall studs or channels after a flood event. Furthermore, because drywall and wood studs or channels are not damaged in a flood, the present invention also helps to conserve resources and eliminate waste associated with flood losses.

The present invention may also reduce healthcare costs caused by a flood. Mold exposure is often a large contributor to healthcare costs associated with a flood. The present invention reduces healthcare costs related to mold exposure because the stainless-steel channels of the present invention dry quickly without fostering mold growth. This reduction in mold growth causes a reduction in healthcare costs associated with mold exposure. Furthermore, because the homeowner can move the drywall out of floodwater's path when there is an expected flood, the drywall will not get wet, grow mold, and cause mold-related health problems.

Another benefit of the present invention is that homeowners will be able to clean up and repair their homes much quicker than with traditional wood stud and drywall arrangements. Because stainless steel dries much quicker than wood, homeowners will be able to begin cleanup and repair to their homes much quicker than if they had to wait for wood studs or channels to dry.

### SUMMARY OF THE INVENTION

The present invention relates to a new specially designed flood-resistant wall with a frame made of support members such as studs or channels. The studs or channels are preferably made of a nonporous material like stainless steel. The flood wall of the present invention further comprises drywall, sheetrock, or some other flat wall material. The flat wall material of the present invention may be attached to the flood wall frame such that the flat wall material is easily movable into a position to avoid flood waters before a flood event.

In one embodiment, the present invention comprises a wall with a frame made of at least a first and second non-porous studs or channels. The present invention may also comprise at least a third non-porous stud or channel connected to the first and second channels such that the at least third channel is substantially perpendicular to the first and second channels.

In one embodiment, a hinge or other mechanical device may be used to connect the flat wall panel to the frame such that the flat wall panel may move relative to the nonporous frame in preparation for a flood event.

The present invention may further include one or more legs attached to the flat wall material. The legs may be used to hold the flat wall in a position substantially perpendicular to the frame in order to avoid water damage during a flood event.

The one or more legs may be telescoping or adjustable and may also be sufficiently strong to hold various household items in preparation for a flood event.

### BRIEF DESCRIPTION OF THE DRAWINGS

FIG. 1 is a front view of an example of a flood wall in a position to avoid flood waters in accordance with one embodiment of the invention;

FIG. 2 is a front view of an example of a flood wall in accordance with one embodiment of the invention;

FIG. 3 is a front view of an example of a flood wall in accordance with the present invention;

FIG. 4 is a front view of an example of a flood wall in accordance with one embodiment of the invention;

FIG. 5 is a back view of an example of a flood wall in accordance with one embodiment of the invention;

### DETAILED DESCRIPTION OF THE INVENTION

The following description of the preferred embodiment(s) is merely exemplary in nature and is in no way intended to limit the invention, its application, or uses. The specific embodiments describing how this may be achieved are not intended to limit the scope of this invention to those embodiments.

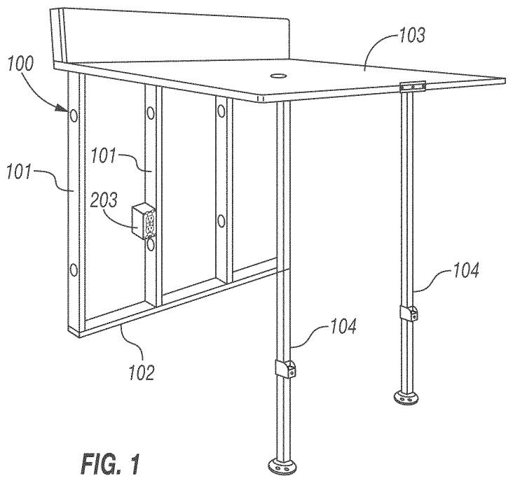

FIGS. 1-5 illustrate the key elements of the flood wall. The features depicted in the figures could be arranged in various different ways and still be covered by the present invention.

One preferred embodiment of the current invention is shown in FIG. 1. The embodiment in FIG. 1 is a wall with a frame 100 comprising a plurality of non-porous studs or channels 101. The embodiment shown in FIG. 1 also comprises a stud or channel 102 attached to the studs 101 such that the stud or channel 102 is perpendicular to the studs 101. The studs 101 and 102 can be attached by any conventional means, including but not limited to, welding or nuts and bolts. The frame could be fabricated off-site in standard-sized sections or it could be fabricated on-site for a custom-sized wall. A person of skill in the art would recognize that the invention is not limited to a frame comprising a specific number of horizontal or vertical studs or channels. The number of studs or channels can vary depending upon various factors such as the size of the wall and the building requirements of the jurisdiction.

The embodiment shown in FIG. 1 has a piece of drywall, sheetrock, or some other type of flat wall material 103 attached to the frame such that the flat wall material is movable to a position that avoids contact with flood waters during a flood event. For example, the flat wall material 103 may be connected to the frame such that it is capable of moving to the position shown in FIG. 1. A hinge or other similar type connection may be used to connect the flat wall material 103 to the frame 100.

The embodiment shown in FIG. 1 may also comprise one or more legs 104 to provide support to the flat wall material when it is in a position to avoid flood waters. The legs 104 may be adjustable or telescoping so the homeowner can prop up the flat wall material to the desired level in preparation for a flood event. For example, if the floors are wood under one portion of the wall and the floors are carpet under another portion of the wall, the legs may be adjusted so that the flat wall material 103 is level.

Conventional means such as a hinge or pivot point may be used to attach the legs 104 to the back of the flat wall material 103. The legs 104 may be folded up behind the flat wall material 103 when they are not being used.

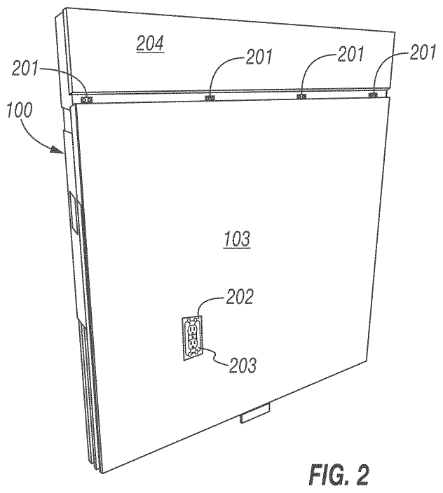

FIG. 2 shows an embodiment of the present invention where the flat wall material 103 in a position for installation in a home. The flat wall material 103 is attached to the frame 101 via hinges 201 so the flat wall material can be lifted to a position to avoid flood waters during a flooding event. The flat wall material 103 has a cutout 202 that allows for access to an electrical outlet 203. FIG. 2 also shows a flat wall material 204 attached to either a portion of the frame 100 or to a portion of the frame existing in the house prior to installation of the flood wall. Although the embodiment of FIG. 2 shows the use of multiple hinges 201 attaching the flat wall material 103 to the frame 100, the present invention also includes using a single long hinge instead of multiple hinges as shown in FIG. 2. The present invention also includes attaching the flat wall material 204 to the frame 100 using other attachment devices know in the art.

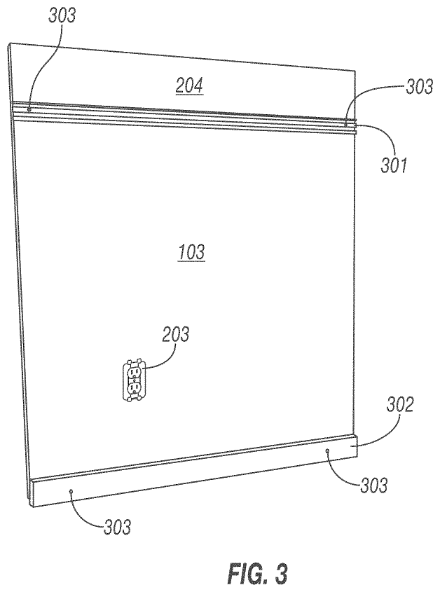

FIG. 3 shows an embodiment of the present invention with trim or moulding added to the base of the wall and along the intersection of the flat wall materials. For example, a chair rail 301 may be added to the wall to cover the hinges 201 and to cover the intersection of the wall materials 103 and 204. A baseboard 302 may also be added to the bottom of the wall to give the wall a finished look. The trim or moulding may be attached to the wall in a traditional manner such as using finishing nails 303. In the event of an impending flood, the homeowner may remove the trim or moulding before lifting the flat wall material 103 into a position to avoid flood waters.

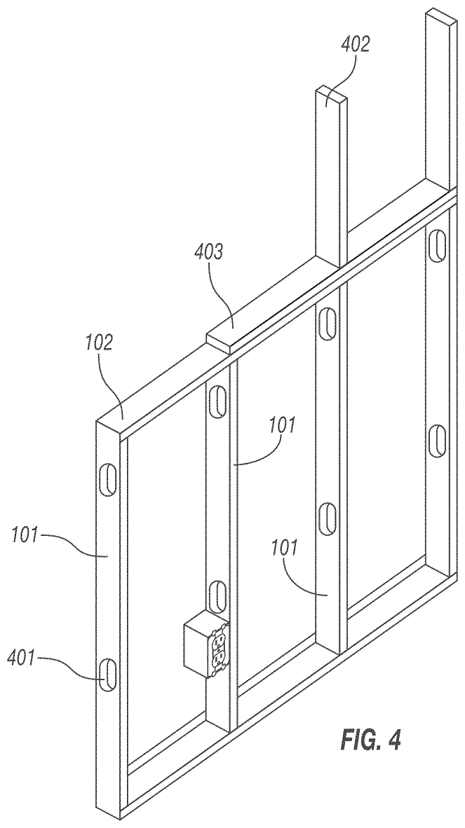

FIG. 4 shows an embodiment of the present invention before installation of any drywall, sheetrock, or other flat wall material. This embodiment comprises four vertical studs or channels 101 and two studs or channels 102 perpendicular to the vertical studs. Each of the vertical channels 101 comprises multiple openings 401 for electrical wires or plumbing to pass through. The electrical outlet 203 is shown attached to one of the vertical channels 101. Above the top channel 102, is an additional stud 402, which may be part of the structure's existing framing and may be made of a porous material or a nonporous material. Also above the top channel 102, is a brace 403, which may be used to mount the flood wall to the frame already existing at the time of wall installation. Flat wall material 204 may be installed above the flood wall frame 100 in a traditional manner such as by using drywall nails.

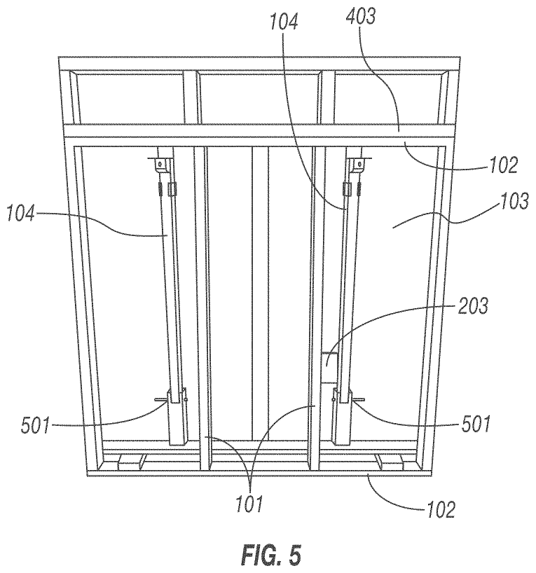

FIG. 5 shows the back side of an embodiment of the present invention. FIG. 5 shows the telescoping or adjustable legs 104 folded up against the back of the flat wall material 103. The legs 104 may be pivotally attached to the flat wall material 103 via a pin and bracket configuration 501 so that the legs can pivot to the engaged position shown in FIG. 1 in preparation of a flood event.

When a flood event is expected, the homeowner can pull the flat wall material 103 up from the bottom and unfold and extend the legs 104 so that the legs 104 hold the flat wall material 103 in a horizontal position as shown in FIG. 1. After the flat wall material 103 is in the desired position and supported by the one or more legs 104, the homeowner may then place valuables or small furniture items on the top of the flat wall material 103 to avoid flood damage to these personal items. When used in this configuration, the present invention keeps the porous flat wall material 102 out of the flood water and provides an elevated storage location for personal belongings during a flood event.

While several embodiments of the present invention have been disclosed hereinabove, it is to be understood that these embodiments are given by example only and not in a limiting sense. Those skilled in the art may make various modifications and additions to the preferred embodiments chosen to illustrate the invention without departing from the spirit and scope of the present contribution to the art. Accordingly, it is to be realized that the patent protection sought and to be afforded hereby shall be deemed to extend to the subject matter claimed and all equivalence thereof fairly within the scope of the invention.

1. A wall for building construction wherein the wall may be installed in a residential or commercial building, said wall comprising:
a frame having a plurality of non-porous support members;
a flat wall material having a first side and a second side;
wherein the flat wall material is attached to said frame such that at least a portion of said flat wall material is movable with respect to the frame;
wherein said flat wall material is the only wall material attached to the frame; and
wherein the flat wall material is made of drywall or gypsum board.

2. The wall of claim 1, further comprising one or more legs attached to said flat wall material.

3. The wall of claim 2, wherein the one or more legs are attached to said flat wall material such that said one or more legs are capable of folding up towards said first side of said flat wall material.

4. The wall of claim 2, wherein the one or more legs are height adjustable.

5. The wall of claim 1, wherein the flat wall material is attached to the frame using a hinge.

6. The wall of claim 3, wherein the one or more legs are pivotally attached to said flat wall material using a pin and bracket configuration.

7.

8.

9.

10.

11.

12.

7. A method for preventing flood water damage to building materials and personal items:
providing a frame having a plurality of non-porous support members;
providing a flat wall material having a first side and a second side; and
attaching the flat wall material to said frame such that at least a portion of said flat wall material is movable with respect to the frame.

8. The method of claim 7, further comprising attaching one or more legs to said flat wall material.

9. The method of claim 8, wherein the one or more legs are attached to said flat wall material such that said one or more legs is capable of folding up towards said flat wall material.

10. The method of claim 7, wherein the flat wall material is attached to the frame using a hinge.

11. The method of claim 8, wherein the one or more legs are height adjustable.

12. The method of claim 8, wherein the one or more legs are pivotally attached to said flat wall material using a pin and bracket configuration.
